(19) United States
(12) Patent Application Publication
(10) Pub. No.: US 2021/0259384 A1
(43) Pub. Date: Aug. 26, 2021

(54) STORAGE ASSEMBLY FOR A SHAVING RAZOR SYSTEM

(71) Applicant: The Gillette Company LLC, Boston, MA (US)

(72) Inventors: Rory Frederick Wellington McGarry, Boston, MA (US); Brian Patrick Watson, Marshfield, MA (US)

(21) Appl. No.: 16/800,145

(22) Filed: Feb. 25, 2020

(51) Int. Cl. A45D 27/22; B26B 21/40

(52) U.S. Cl. CPC A45D 27/225; B26B 21/40

(57) ABSTRACT

A storage assembly for a shaving razor system including a case with a top portion and a bottom portion and an insert including a material having a Shore A hardness of between 40 and 70. The insert includes one or more cavities configured to receive one or more components of the shaving razor system, and the bottom portion of the case defines a compartment configured to removably receive the insert within the bottom portion. Also provided is a method of assembling a storage assembly for a shaving razor system.

### FIELD OF THE INVENTION

The invention generally relates to a storage assembly for a shaving razor system, and more particularly to an insert for storing one or more components of a shaving razor system.

### BACKGROUND OF THE INVENTION

Conventional product packaging options for personal care products, such as shaving razors, include a significant amount of single-use plastic material that is discarded after the product is purchased. In recent years, consumers have become increasingly aware of the environmental impact of such product packaging and have begun to call for more sustainable and cost-effective packaging. Accordingly, newer packaging designs typically utilize paperboard (e.g., cardboard or molded pulp) boxes and/or inserts, which may be easily recycled. However, reusing has been determined to be a better alternative to recycling because it saves the energy that comes with having to collect, sort and re-manufacture products. It also significantly reduces waste and pollution because it reduces the need for raw materials and transportation saving both forests and water supplies.

It would be desirable to provide durable, multi-use packaging for a shaving razor system that could be used both to display the product in a retail environment and store the product during consumer use resulting in minimum waste.

### SUMMARY OF THE INVENTION

In accordance with an aspect of the present disclosure, a storage assembly for a shaving razor system is provided that includes a case with a top portion and a bottom portion and an insert including a material having a Shore A hardness of between 40 and 70. The insert includes one or more cavities configured to receive one or more components of the shaving razor system, and the bottom portion of the case defines a compartment configured to removably receive the insert within the bottom portion.

In accordance with another aspect of the present disclosure, a storage assembly for a shaving razor system is provided, in which the shaving razor system includes a razor cartridge either alone or in combination with a protective overcap and the assembly includes a case with a top portion and a bottom portion and an insert received in the bottom portion of the case. The insert includes a cavity configured to receive the razor cartridge either alone or with the protective overcap. The insert further includes a ledge positioned within the cavity and configured to engage and support the protective overcap when the protective overcap is mounted to the razor cartridge.

In accordance with a further aspect of the present disclosure, a method of assembling a storage assembly for a shaving razor system is provided, the method including: providing an insert including a deformable material, in which the insert includes one or more cavities configured to receive one or more components of the shaving razor system; providing a case with a top portion and a bottom portion, in which the bottom portion of the case defines a compartment configured to removably receive the insert and the insert includes at least one first dimension that is greater than a corresponding second dimension of an opening into the compartment; deforming the insert; inserting the deformed insert into the opening of the compartment; placing the one or more components of the shaving razor system into the one or more cavities in the insert; and securing the top and bottom portions of the case together.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1A is a perspective view of a storage assembly for a shaving razor system comprising a razor handle and a razor cartridge, in accordance with the present disclosure, in which a case is in an open position;

FIG. 1B is a perspective view of the storage assembly of FIG. 1A, in which the case is in a closed position;

FIG. 2 is a perspective cross-sectional view taken along line 2-2 in FIG. 1A, in which the razor handle and a top portion of the case are removed;

FIG. 3 is a perspective cross-sectional view taken along line 3-3 in FIG. 1A, in which the top portion of the case is removed and the razor cartridge is depicted without a protective overcap;

FIG. 4 is a cross-sectional view taken along line 4-4 in FIG. 1A;

FIG. 5 is a detailed perspective cross-sectional view similar to FIG. 4, in which the razor cartridge is depicted with a protective overcap;

FIG. 6 is a detailed perspective cross-sectional view similar to FIG. 5, in which the razor cartridge is removed;

FIG. 7 is a perspective view of a bottom of an insert for a shaving razor system, in accordance with the present disclosure;

FIG. 8 is a top view of an additional storage assembly for a shaving razor system, in accordance with the present disclosure;

FIG. 9 is a perspective view of an additional storage assembly for a shaving razor system, in accordance with the present disclosure; and

FIGS. 10 and 11 are flow diagrams of methods of assembling a storage assembly for a shaving razor system, in accordance with the present disclosure.

### DETAILED DESCRIPTION OF THE INVENTION

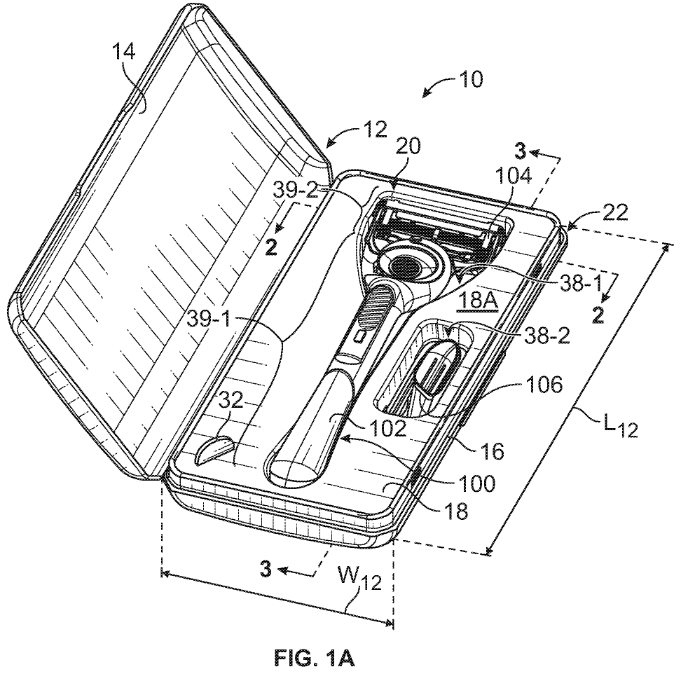

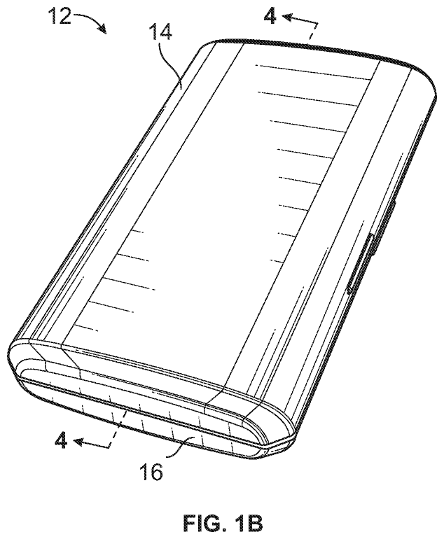

Referring to FIGS. 1A, 1B, and 2-4, a storage assembly 10 is illustrated. The storage assembly 10 may comprise a case 12 with a top portion 14 and a bottom portion 16 and an insert 18 and 18′ each comprising a respective front face 18A and 18A′ and rear face 18B and 18B′. As described herein in detail, the inserts 18 and 18′ may each comprise one or more respective cavities 38 and 38′ configured to receive one or more components of a shaving razor system 20. The case 12 comprises a longitudinal length Lie and a lateral width W₁₂. The top and bottom portions 14 and 16 may comprise an engineering plastic, such as a polycarbonate, a metal, or a metal alloy, such as steel, aluminum, tin, or combinations thereof. As will be described in greater detail below, the insert 18 and 18′ may be removable, thus allowing for easy cleaning and drying of the inserts 18 and 18′ and the case 12.

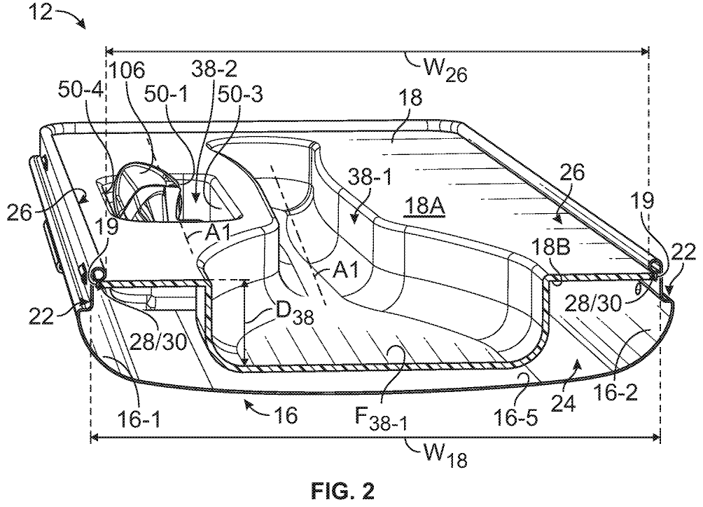

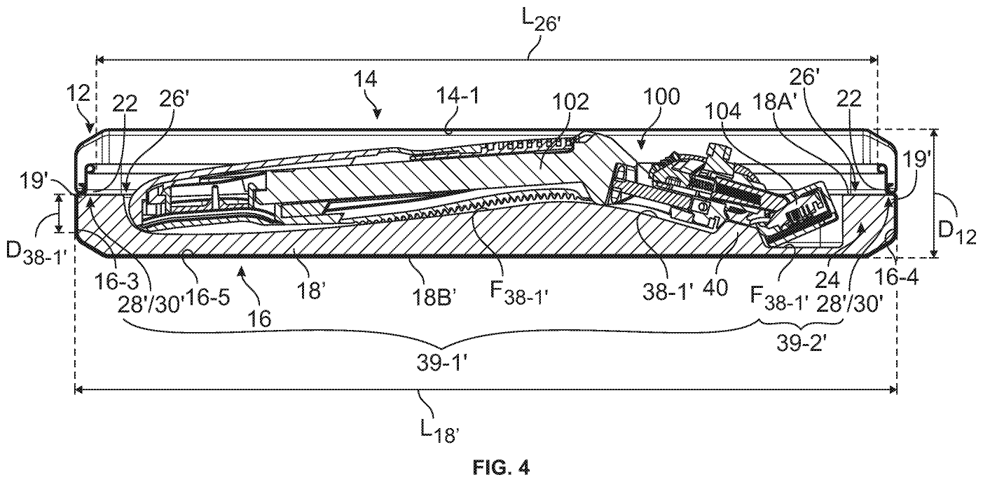

The top and bottom portions 14 and 16 of the case 12 may be coupled together, e.g., by a hinge (not shown) so as to be movable relative to one another between an open position (see FIG. 1A) and a closed position (see FIGS. 1B and 4). In some examples, a section of the bottom portion 16 may be received in the top portion 14 when the case 12 is in the closed position. As shown in FIGS. 2-4, the bottom portion 16 may comprise side walls 16-1, 16-2, 16-3, and 16-4, and one or more of the side walls 16-1 to 16-4 may comprise an indent 22, in which a portion of the side wall(s) 16-1 to 16-4 extends inward toward an interior of the case 12. The indent 22 may extend around at least a section of the bottom portion 16. When the case 12 is moved to the closed position, a section of the top portion 14 may extend over and be received in the indent 22 formed in the bottom portion 16. The top and bottom portions 14 and 16 may be secured together and the case 12 may be maintained in the closed position, at least in part, by an interference fit between the top and bottom portions 14 and 16.

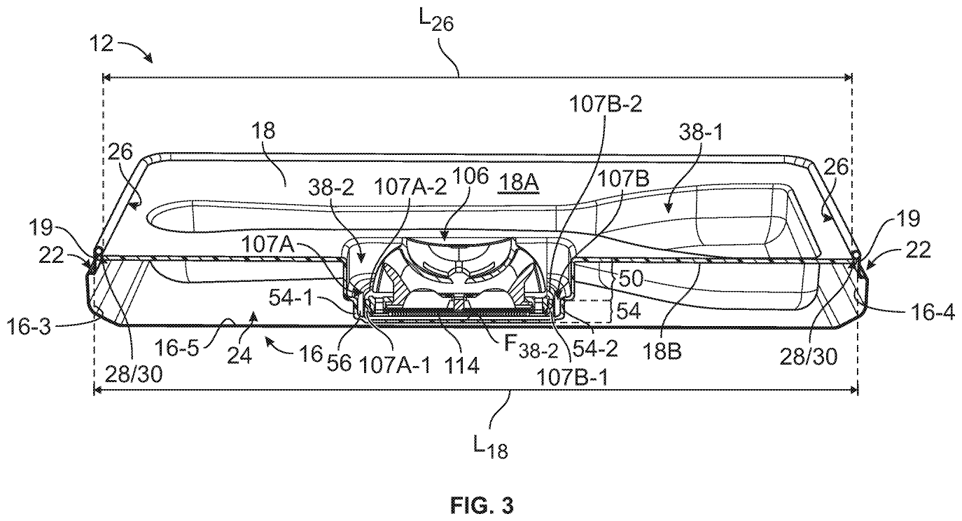

The bottom portion 16 of the case 12 defines a compartment 24 that is configured to removably receive a respective one of the inserts 18 and 18′. With reference to FIGS. 2 and 3, the compartment 24 is at least partially defined by the side walls 16-1 to 16-4 and a bottom wall 16-5 of the bottom portion 16 of the case 12. The bottom portion 16 of the case 12 may comprise a first peripheral edge 30 that extends away from one or more of the side walls 16-1 to 16-4 and at least partially defines a first periphery or a first opening 26 into which the insert 18 is introduced into the compartment 24. At least a portion of the peripheral edge 30 may define a first retainer 28 that extends over at least a portion of the insert 18 when the insert 18 is received in the compartment 24. It is also contemplated that the first retainer 28 may comprise structure separate from or in addition to the peripheral edge 30. In the example shown in FIGS. 2 and 3, the side walls 16-1 to 16-4 of the bottom portion 16 may terminate in rolled upper edges that extend inward toward each other so as to define the peripheral edge 30 and the first retainer 28 for the first compartment 24. When the insert 18 is received in the compartment 24, the rolled upper edges of the bottom portion 16 extend over at least a portion of the insert 18, and outer edges 19 of the insert 18 contact the rolled upper edges of the bottom portion 16 to hold the insert 18 in place in the compartment 24.

With reference to FIG. 4, the bottom portion 16 of the case 12 may comprise an inwardly located second peripheral edge 30′ that is defined by the indent 22 formed in the side walls 16-1 to 16-4 of the bottom portion 16. The second peripheral edge 30′ may define a second periphery or a second opening 26′ into which the insert 18′ is introduced into the compartment 24. At least a portion of the second peripheral edge 30′ may also define a second retainer 28′ that extends over at least a portion of the insert 18′ when the insert 18′ is received in the compartment 24. The peripheral edge 30′ may be defined by one or more inwardly extending portions of one or more of the side walls 16-1 to 16-4. When the insert 18′ is received in the compartment 24, the portion(s) of the side walls 16-1 to 16-4 defining the indent 22 and the second peripheral edge 30′ extend over at least a portion of the insert 18′, and outer edges 19′ of the insert 18′ contact the portion(s) of the side walls 16-1 to 16-4 to hold the insert 18′ in place in the compartment 24.

Although the respective retainers 28, 28′ are depicted in FIGS. 2-4 as being substantially continuous and extending completely around the respective openings 26 and 26′, it is understood that the retainers 28, 28′ may be discontinuous and may comprise, for example, one or more discrete extensions or protrusions that extend away from one or more of the side walls 16-1 to 16-4 and over one or more portions of the inserts 18 and 18′. In addition, although the outer edges 19 and 19′ of the respective inserts 18 and 18′ are depicted in FIGS. 2-4 as contacting the respective retainer 28 and 28′ all the way around the openings 26 and 26′, it is understood that the inserts 18 and 18′ may comprise any desired shape and may contact only a portion of the respective retainer 28 and 28′. For example, the inserts 18 and 18′ may comprise one or more cutouts (not shown) to accommodate the hinge or other components of the case 12.

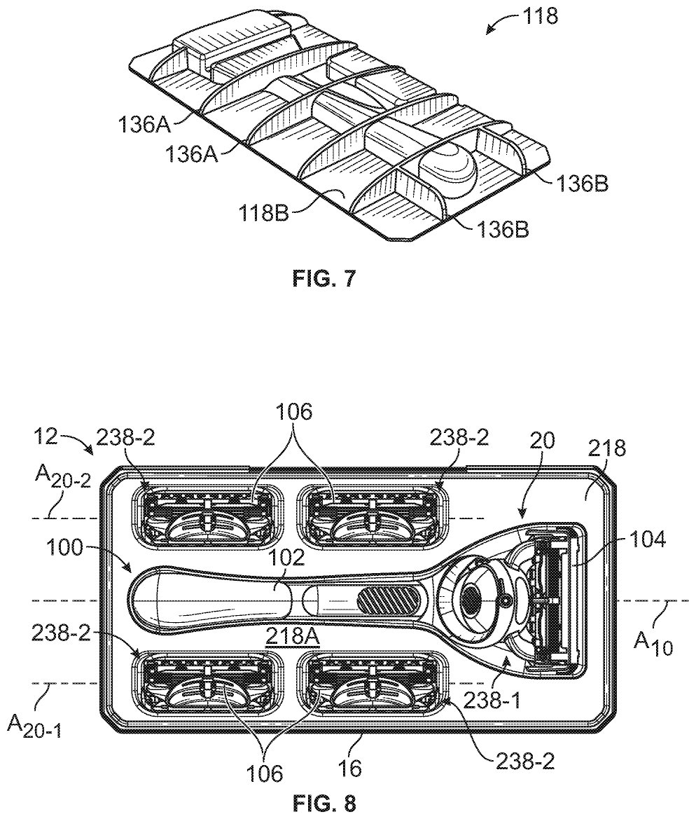

In an example first insert 18, as shown in FIGS. 2 and 3, the rear face 18B of the insert 18 may be substantially planar except for the one or more cavities 38 extending outward from the rear face 18B, and one or more portions of the cavities 38 may contact the bottom wall 16-5 of the bottom portion 16 and may act as a stabilizing feature to support the insert 18 and prevent the insert 18 from tilting or shifting in the compartment 24 of the bottom portion 16. In another example third insert 118, as shown in FIG. 7, a rear face 118B of the insert 118 may comprise a plurality of ribs 136A and 136B extending outward from the rear face 118B. The ribs 136A may extend laterally, i.e., across at least a portion of a width (not labeled; see FIG. 2) of the insert 118, and the ribs 136B may extend longitudinally, i.e., across at least a portion of a length (not labeled; see FIGS. 3 and 4) of the insert 118. The ribs 136A and 136B may act as stabilizing features to help to support and stabilize the insert 118 when the insert 118 is inserted into the case (see FIG. 4) and prevent the insert 118 from tilting or shifting in the compartment 24 of the bottom portion 16.

The ribs 136A and 136B may optionally conform to a shape of at least a section of the bottom portion 16 of the case 12. For example, the ribs 136A and 136B of the insert 118 shown in FIG. 7 are depicted as being curved, and this curvature may help to stabilize the insert 118 in the case 12 shown in FIG. 2, in which at least a portion of the bottom wall 16-5 of the bottom portion 16 is curved. It is understood that the bottom portion 16 may comprise any desirable shape (e.g., a shape in which the bottom wall 16-5 is substantially planar), and the inserts 18, 18′, and 118′ may comprise one or more stabilizing features (e.g., ribs, discrete extensions or feet, etc.) configured to conform to the shape of the bottom portion 16 and support and stabilize the insert 18, 18′, and 118.

Inserts in accordance with the present disclosure may be sufficiently flexible and deformable to allow for repeated placement in, and removal from, the bottom portion 16 of the case 12 without damage to the insert. Although the following discussion is provided with respect to the inserts 18 and 18′ shown in FIGS. 2-4, it is understood that all inserts described herein may comprise similar properties and features. With reference to FIGS. 2-4, the inserts 18 and 18′ may be sufficiently flexible and deformable to allow for insertion of the inserts 18 and 18′ through the respective opening 26 and 26′ and into the compartment 24 defined in the bottom portion 16 of the case 12. The inserts 18 and 18′ are also expandable to allow the inserts 18 and 18′ to return to generally an original or initial shape so as to be retained in the compartment 24. In some examples, the inserts 18 and 18′ may comprise a deformable material having a Shore A hardness of between 40 and 70. In other examples, the inserts 18 and 18′ may comprise a material such as silicone or a thermoplastic elastomer.

In some examples, the inserts 18 and 18′ may comprise at least one first dimension that is greater than a corresponding second dimension of the openings 26 and 26′ of the compartment 24 into which the inserts 18 and 18′ are received, as shown in FIGS. 2-4. For instance, with reference to FIGS. 2 and 3, the insert 18 may comprise a width Wig and a length L₁₈, in which the width W₁₈ of the insert 18 is greater than a width W₂₆ of the opening 26 and/or the length Lis of the insert 18 is greater than a length L₂₆ of the opening 26. As shown in FIG. 4, the insert 18′ may similarly comprise a length L_{18′} that is greater than a length L_{26′} of the opening 26′. Although not visible in FIG. 4, the insert 18′ may also comprise a width that is greater than a width of the opening 26′. In some examples, the length L₁₈, and L_{18′} and width Wig may comprise a maximum length and width of the respective insert 18 and 18′. The length L₂₆ and L_{26′} and width W₂₆ may similarly comprise a maximum length and width of the respective opening 26 and 26′. It may be seen in FIGS. 2-4 that at least a portion of the compartment may comprise a length and/or width (not labeled) that is substantially similar to, or greater, than the length L₁₈/L_{18′} and/or width W₁₈ of the respective inserts 18 and 18′.

To place the inserts 18 and 18′ in the compartment 24, the inserts 18 and 18′ may be deformed (i.e., crumpled, folded, bended, rolled, etc.) from an initial or “resting” state to a deformed state, such that at least one dimension, e.g., the width Wig and/or length L₁₈/L_{18′}, of the insert 18 and 18′ is less than the corresponding dimension W₂₆ and/or L₂₆/L_{26′} of the respective opening 26 and 26′. The deformed inserts 18 and 18′ may then be inserted through the respective opening 26 and 26′ into the compartment 24. Upon release inside the compartment 24, the deformed inserts 18 and 18′ may return to their initial or resting state with their initial respective shape and dimensions. With reference to FIGS. 3 and 4, it is noted that the opening 26 defined by the rolled upper edges of the side walls 16-1 to 16-4 is smaller than the opening 26′ defined by the indent 22 and that the insert 18′ would also be sufficiently deformable to allow the insert 18′ to be inserted past the rolled upper edges of the side walls 16-1 to 16-4. As shown in FIGS. 2-4 and described above, the outer edges 19 and 19′ of the respective insert 18 and 18′ contact and engage the respective retainer 28 and 28′ to hold the inserts 18 and 18′ in place in the compartment 24. The inserts 18 and 18′ are also removable from the case 12 by grasping and deforming the inserts 18 and 18′ from the initial or resting state to the deformed state, as described herein, and removing the deformed inserts 18 and 18′ from the compartment 24 through the respective opening 26 and 26′. After removal from the compartment 24, the inserts 18 and 18′ return to their initial or resting state with their initial respective shape and dimensions.

As shown in FIG. 1A, the front face 18A of the insert 18 may optionally comprise one or more pull tabs 32 extending outward from the front face 18A in a direction that is substantially perpendicular to a plane (not labeled) defined by the front face 18A of the insert 18. The pull tab(s) 32 assist with grasping the insert 18 and allow for easy removal of the insert 18 from the bottom portion 16 of the case 12. For example, a user may remove the insert 18 by gripping the pull tab 32 and pulling the insert 18 out of the compartment 24 without the need to grasp any other portions of the insert 18. A height of the pull tab 32, as measured in a direction extending outward from the front face 18A, may be greater than a thickness of the pull tab 32. The pull tab(s) 32 may be placed at one or more suitable locations, such as, for example, near one or more corners of the insert 18 as shown in FIG. 1A. Although the pull tab 32 is shown with respect to the insert 18 of FIG. 1A, it is understood that the pull tab 32 may be used with any of the inserts described herein.

With continued reference to FIGS. 2-4, in some examples, the inserts 18 and 18′ are sized so that when the inserts 18 and 18′ are positioned in the compartment in the case 12, one or more sidewalls of the inserts 18 and 18′ engage one or more corresponding side walls 16-1 to 16-4 of the bottom portion 16 of the case 12 so as to define a substantially watertight seal with the one or more corresponding side walls 16-1 to 16-4 of the bottom portion 16 of the case 12. In other examples, the inserts 18 and 18′ may optionally be free of any drainage openings that extend through a thickness (not shown; see Tis in FIG. 6) of the inserts 18 and 18′. The watertight seal and/or lack of drainage openings helps to prevent water and/or other liquids from reaching the bottom portion 16 of the case 12. As described herein, because the insert 18 and 18′ is for receiving one or more components of a shaving razor system 20, the case 12 may be used and/or stored in a wet environment and may be exposed to shaving cream, soap, and other personal care products. The case 12 is intended to be durable and reusable, and one or both of the top and bottom portions 14 and 16 of the case 12 may be metal. To prolong the useful life of the case 12, it may be desirable to limit or prevent introduction of water and other liquids into the bottom portion 16 to help prevent rust, corrosion, and other damage to the case 12.

The inserts 18 and 18′ may be manufactured by, for example, molding. The inserts 18 and 18′, which are also intended to be durable and reusable, may comprise a material such as silicone or a thermoplastic elastomer that is substantially inert and resistant to damage by temperature and by water, soap, and/or other liquids that may contact the inserts 18 and 18′ during use in a home environment. The material of the inserts 18 and 18′ may further comprise a material that is resistant to microbial (e.g., bacterial and/or fungal) growth or may optionally be treated to incorporate one or more antimicrobial ingredients. The inserts 18 and 18′ are also removable for cleaning separate from the case 12 to further help prevent damage to the case 12 due to contact with water or cleaning chemicals.

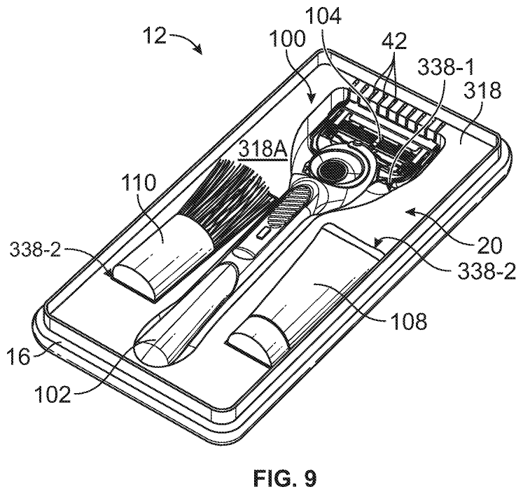

With reference to FIGS. 1A and 2-4, the inserts 18 and 18′ may be configured to receive one or more components of the shaving razor system 20. In one example, the shaving razor system 20 may comprise a shaving razor 100, which may comprise a razor handle 102 alone or with a razor cartridge 104 attached to the razor handle 102. The shaving razor system 20 may also comprise an additional razor cartridge 106 that is not attached to the razor handle 102. FIGS. 8 and 9 illustrate other examples of shaving razor systems 20. As shown in FIGS. 8 and 9, the shaving razor system 20 may comprise a shaving razor 100, along with a plurality of additional razor cartridges 106 that are not attached to the razor handle 102 (see FIG. 8) and/or one or more accessories (see FIG. 9) such as a tube 108 of shaving cream, soap, lotion, etc. and/or a brush 110 for applying shaving cream.

As shown in FIGS. 1A, 2-4, 8, and 9, the inserts 18, 18′, 218, and 318 may each comprise one or more respective cavities 38, 38′, 238, and 338 that are each configured to receive one of the components of the shaving razor system 20. With reference to FIGS. 1A and 2-4, the first and second inserts 18 and 18′ may each comprise a respective first cavity 38-1 and 38-1′ that extends into a main body of the respective insert 18 and 18′ from a front face 18A and 18A′ of the respective insert 18 and 18′ and is configured to receive a shaving razor 100. The inserts 218 and 318 in FIGS. 8 and 9 may also comprise a respective first cavity 238-1 and 338-1 that extends inward from a front face 218A and 318A of the respective insert 218 and 318 and is configured to receive a shaving razor 100.

With reference to FIGS. 1A, 2, 3, 8, and 9, the inserts 18, 218, and 318 may further comprise one or more respective second cavities 38-2, 238-2, and 338-2. The shape and/or dimensions of the one or more second cavities 38-2, 238-2, and 338-2 may be adjusted as desired to receive components of varying size and shape. As shown in FIGS. 1A, 2, and 3, the insert 18 may comprise a second cavity 38-2 that is configured to receive an additional razor cartridge 106 that is not attached to the razor handle 102. As shown in FIG. 8, when the insert 218 comprises two or more second cavities 238-2, the second cavities 238-2 may all comprise a similar size and shape and may be configured for receiving one type of component, e.g., a plurality of additional razor cartridges 106. As shown in FIG. 9, the insert 318 may comprise two or more second cavities 338-2 with different size(s) and/or shape(s) and may be configured for receiving different components. For example, the second cavities 338-2 may each be configured to receive an accessory, such as a tube 108 and/or a brush 110. Although not visible in FIG. 4, it is understood that the insert 18′ may also comprise, for example, at least one second cavity for receiving an additional razor cartridge 106 and/or accessory 108/110, as described herein.

As shown in FIGS. 1A, 4, and 7-9, the dimensions and shape of the inserts 18, 18′, 118, 218, 318 may be such that the inserts 18, 18′, 118, 218, 318 are interchangeable and may all be used with the same case 12. For example, a manufacturer may make a single type of case 12 and may manufacture different inserts 18, 18′, 118, 218, 318 that may be used with the case 12. In addition, the inserts 18, 18′, 118, 218, 318 may be interchangeable such that a user who purchases a case 12 with, for example, the insert 18 as shown in FIG. 1A, may purchase different inserts 18′, 118, 218, 318 for use with the same case 12 to hold different shaving razor systems, accessories, etc.

The cavities 38, 38′, 238, and 338 may be positioned so as to maximize the number of components of the shaving razor system 20 that may be received in the respective inserts 18, 18′, 218, and 318. With reference to FIGS. 1A, 2, and 3, the longitudinal length L₁₂ of the case 12 may be greater than the lateral width W₁₂ of the case 12, and the first and second cavities 38-1 and 38-2 may be arranged to maximize usage of space within the case 12. For example, the first cavity 38-1 may comprise a first portion 39-1 that extends along at least a part of the longitudinal length L₁₂ of the case 12 and is configured to receive the razor handle 102; and a second portion 39-2 that extends along at least a part of the lateral width W₁₂ of the case 12 and is configured to receive the razor cartridge 104 attached to the razor handle 102. As shown in FIGS. 1A, 2, and 3, the second cavity 38-2 that is configured to receive the additional razor cartridge 106 may extend along at least a part of the lateral length L₁₂ of the case 12 and may be positioned transverse to a direction of the second portion 39-2 of the first cavity 38-1. As shown in FIG. 2, the first cavity 38-1 may also define a first longitudinal axis A₁, and the second cavity 38-2 may define a second longitudinal axis A₂ that is parallel to the first longitudinal axis A₁.

The first cavity 38-1′ in FIG. 4 may similarly comprise a first portion 39-1′ that extends along at least a part of the longitudinal length (not shown; see L₁₂ in FIG. 1A) of the case 12 and is configured to receive the razor handle 102; and a second portion 39-2′ that is configured to receive the razor cartridge 104 attached to the razor handle 102. The first cavity 38-1′ may define a first longitudinal axis (not shown; see Ai in FIG. 2). Although not visible in FIG. 4, the insert 18′ may comprise a second cavity that is substantially similar to the second cavity 38-2 depicted in FIGS. 1A, 2, and 3 and extends along at least a part of the lateral length (not shown; see L₁₂ in FIG. 1A) of the case 12 transverse to a direction of the second portion 39-2′ of the first cavity 38-1′.

With reference to FIG. 8, the first cavity 238-1 of the insert 218 may be shaped and sized so as to be substantially similar to either of the first cavities 38-1 or 38-1′ shown in FIGS. 1A and 2-4 and may comprise a first portion (not labeled) that extends along at least a part of the longitudinal length (not labeled) of the case 12 and is configured to receive the razor handle 102; and a second portion (not labeled) that extends along at least a part of the lateral width (not labeled) of the case 12 and is configured to receive the razor cartridge 104 attached to the razor handle 102. Similar to the second cavity 38-2 in FIGS. 1A, 2, and 3, the second cavities 238-2 in FIG. 8, each of which are configured to receive an additional razor cartridge 106, may extend along at least a part of the lateral length of the case 12 and may be positioned transverse to a direction of the second portion of the first cavity 238-1. The first cavity 238-1 may define a first longitudinal axis A₁₀. The insert 218 may be configured such that a pair of second cavities 238-2 are located on each side of the first cavity 238-1. One pair of second cavities 238-2 may define a second longitudinal axis A₂₀₋₁, and the other pair of second cavities 238-2 may define a third longitudinal axis A₂₀₋₂, in which the second and third longitudinal axes A₂₀₋₁ and A₂₀₋₂ are both parallel to the first longitudinal axis A₁₀.

With reference to FIG. 9, the first cavity 338-1 of the insert 318 may be shaped and sized so as to be substantially similar to either of the first cavities 38-1 or 38-1′ shown in FIGS. 1A and 2-4 and may comprise a first portion (not labeled) that extends along at least a part of the longitudinal length (not labeled) of the case 12 and is configured to receive the razor handle 102; and a second portion (not labeled) that extends along at least a part of the lateral width (not labeled) of the case 12 and is configured to receive the razor cartridge 104 attached to the razor handle 102. Similar to the second cavity 38-2 in FIGS. 1A, 2, and 3, the second cavities 338-2 in FIG. 9 may extend along at least a part of the lateral length of the case 12 and may be positioned transverse to a direction of the second portion of the first cavity 338-1. The first cavity 338-1 may define a first longitudinal axis (not shown; see A₁ and A₁₀ in FIGS. 2 and 8). The insert 318 may be configured such that the second cavities 338-2 are located on either side of the first cavity 338-1. One of the second cavities 338-2 (e.g., the second cavity 338-2 configured to receive the tube 108) may define a second longitudinal axis (not shown; see A₂ and A₂₀₋₁ in FIGS. 2 and 8) and the other second cavity 338-2 (e.g., the second cavity 338-2 configured to receive the brush 110) may define a third longitudinal axis (not shown; see A₂₀₋₂ in FIG. 8), in which the second and third longitudinal axes defined by the second cavities 338-2 are both parallel to the first longitudinal axis defined by the first cavity 338-1.

With continued reference to FIG. 9, the insert 318 may optionally comprise a plurality of aeration slots 42 that extend partially through a thickness (not shown; see T₁₈ in FIG. 6) of the insert 318 and communicate with the first cavity 338-1. The aeration slots 42 may comprise a plurality of spaced-apart slots located near the razor cartridge 104 and may extend in a direction substantially parallel to a first longitudinal axis (not shown; see Ai in FIG. 2) of the first cavity 338-1. The aeration slots 42 may help to remove excess moisture from the first cavity 338-1 and the razor cartridge 104 following use.

The dimension(s), shape, and the like of at least a portion of each cavity 38, 38′, 238, and 338 may be adjusted as desired so as to conform to the dimension(s), shape, etc. of at least a portion of the component of the shaving razor system 20 that the cavity 38, 38′, 238, and 338 is configured to receive. For example, with reference to FIGS. 1A and 2, the first and second portions 39-1 and 39-2 of the first cavity 38-1 may comprise a shape and dimensions that substantially correspond to the shape and dimensions of at least a portion of the razor handle 102 and the razor cartridge 104, respectively, as measured in a direction parallel to the length and width L₁₂ and W₁₂ of the case 12. The second cavity 38-2 may likewise comprise a shape and dimensions that substantially correspond to the shape and dimensions of at least a portion of the additional razor cartridge 106, as measured in a direction parallel to the length and width L₁₂ and W₁₂ of the case 12. The first and second cavities 38-1′, 238-1, 338-1, 238-2, and 338-2 of the respective inserts 18′, 218, and 318 in FIGS. 4, 8, and 9 may similarly comprise shapes and dimensions that substantially correspond to the shape and dimensions of at least a portion of the razor handle 102, the razor cartridge 104, the additional razor cartridge(s) 106, the tube 108, and/or the brush 110 that are received therein, as measured in a direction parallel to the length L₁₂ and width W₁₂ of the case 12 (see FIG. 1).

In some examples, as shown in FIG. 2, a floor F₃₈₋₁ of the first cavity 38-1 may be substantially planar, and the first cavity 38-1 may comprise a substantially uniform depth D₃₈ along substantially an entirety of the first cavity 38-1. In other examples, as shown in FIG. 4, a depth D_{38-1′} of the first cavity 38-1′ may vary along one or more sections of the first cavity 38-1′. In particular, a floor F_{38-1′} of the first cavity 38-1′ may comprise one or more sections in the first portion 39-1′ that are curved to correspond to a curvature and/or shape of the razor handle 102, such that the first cavity 38-1′ supports the razor handle 102. The insert 18′ may further comprise a support rib 40 that extends upward from the floor F_{38-1′} and into the first cavity 38-1′. The support rib 40 may extend across generally an entire width of the first portion 39-1′ of the first cavity 38-1′.

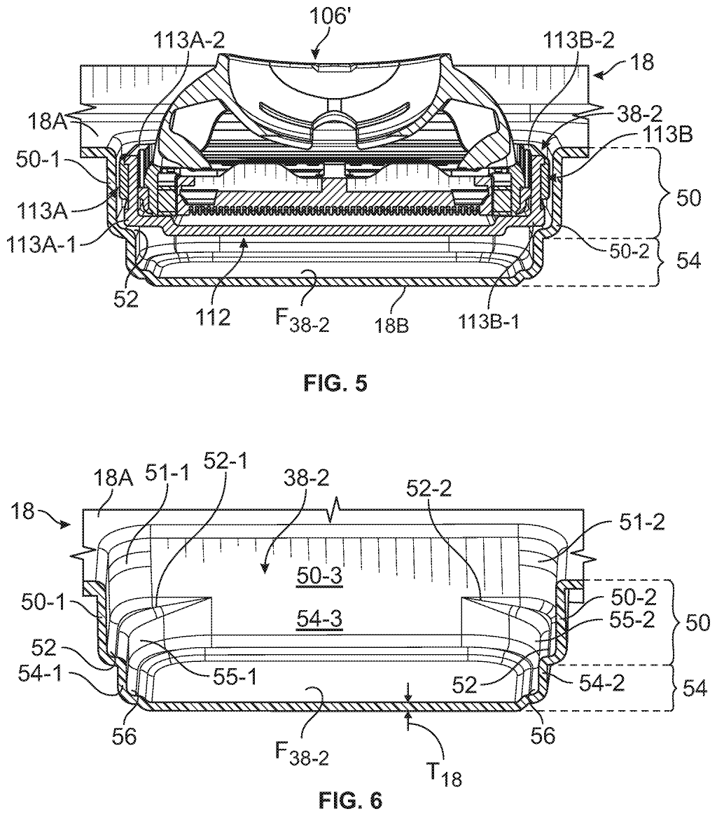

As shown in FIG. 4, the razor cartridge 104 may be adjacent to and/or face the floor F_{38-1′} of the first cavity 38-1′, and the support rib 40 may engage at least a portion of the razor handle 102 and/or the razor cartridge 104, such that substantially at least a portion of the razor cartridge 104 that is adjacent to/faces the floor F_{38-1′} is spaced apart from, i.e., spaced above, the floor F_{38-1′} of the first cavity 38-1′. Following use, the shaving razor 100 may be placed in the first cavity 38-1′ with a protective overcap (not labeled; see 112 in FIG. 5) mounted to the razor cartridge 104 as shown in FIG. 4, and the support rib 40 engages a portion of the razor handle 102 and/or the razor cartridge 104 such that only a small portion of the razor cartridge 104, i.e., an outer edge of the protective overcap, contacts the floor F_{38-1′} of the first cavity 38-1′. In some examples, at least 50% of the razor cartridge 104 facing the floor F_{38-1′} is spaced apart from the floor F_{38-1′}. In other examples, at least 60%, at least 70%, at least 80%, at least 90%, at least 95%, or at least 99% of the razor cartridge 104 is spaced apart from the floor F_{38-1′}. In other examples, the support rib 40 may engage the razor handle 102 and/or razor cartridge 104 such that an entirety of the razor cartridge (including the protective overcap) is spaced apart from the floor F_{38-1′}. It can be seen from FIG. 4 that when the shaving razor 100 is placed in the first cavity 38-1′ without the protective overcap, engagement between the support rib 40 and the razor handle 102 and/or the razor cartridge 104 ensures that all parts of the razor cartridge 104 that are adjacent to and/or face the floor F_{38-1′}, e.g., the blade(s), lubrication strip(s), guard(s), etc., are spaced apart from and avoid contact with the floor F_{38-1′} of the first cavity 38-1′. The support rib 40 may also help to prevent unwanted side-to-side tilting motion of the razor handle 102 following placement of the shaving razor 100 in the first cavity 38-1′. The first cavities 238-1 and 338-1 depicted in FIGS. 8 and 9 may comprise a structure that is substantially similar to either of the first cavities 38-1 and 38-2 in FIGS. 2 and 4.

The second cavity 38-2 may similarly comprise a substantially uniform depth (not shown) or may comprise a depth that varies along one or more sections of the second cavity, as shown in FIGS. 3, 5, and 6. In particular, the second cavity 38-2 may be configured to receive an additional razor cartridge 106′ with a protective overcap 112, as shown in FIG. 5, or to receive the razor cartridge 106 alone (i.e., without the overcap 112), as shown in FIG. 3, in which the razor cartridge 106, 106′ is received at a different level within the second cavity 38-2 depending on whether the overcap 112 is present or absent. The insert 18 may comprise a first ledge 52 and a second ledge 56, each of which are positioned within the second cavity 38-2. With reference to FIGS. 2, 5, and 6, the second cavity 38-2 may comprise a first section 50 defined by the first ledge 52 and first, second, third, and fourth side walls 50-1, 50-2, 50-3, and 50-4. With reference to FIGS. 3 and 6, the second cavity 38-2 may further comprise a second section 54 defined by the second ledge 56 and first, second, third, and fourth side walls (only first, second, and third side walls 54-1, 54-2, and 54-3 are visible).

As shown in FIG. 6, the first ledge 52 may comprise two discrete portions 52-1 and 52-2 located along a perimeter of the second cavity 38-2 in the first section 50. The second ledge 56 may be substantially continuous and may extend around an entirety of the perimeter of the second cavity 38-2 in the second section 54. Although not shown, it is understood that the first ledge 52 may comprise a substantially continuous structure similar to the second ledge 56 and/or that the second ledge 56 may comprise two or more discrete portions similar to the first ledge 52.

With reference to FIGS. 5 and 6, the first ledge 52 is configured to engage and support the overcap 112 when the overcap 112 is mounted to the razor cartridge 106′. The overcap 112 may comprise a hard plastic cover that fits over the razor cartridge 106′ to protect it from damage and to protect a user from injury by inadvertent contact with blades (not visible; see 114 in FIG. 3) of the razor cartridge 106′. When the razor cartridge 106′ with the overcap 112 is received in the second cavity 38-2, the overcap 112 and the razor cartridge 106′ rest on a portion of the first ledge 52. In particular, the overcap 112 comprises outer ends 113A and 113B, and the first ledge 52 engages a portion 113A-1 and 113B-1 of each respective outer end 113A and 113B to support the overcap 112 and the razor cartridge 106′.

With reference to FIGS. 3 and 6, the second ledge 56 is configured to directly engage and support the razor cartridge 106 when the overcap 112 is removed. When the razor cartridge 106 without the overcap 112 is received in the second cavity 38-2, the razor cartridge 106 rests on a portion of the second ledge 56. In particular, the razor cartridge 106 comprises outer edges 107A and 107B, and the second ledge 56 engages a portion 107A-1 and 107B-1 of each respective outer edge 107A and 107B to support the razor cartridge 106.

As shown in FIGS. 3, 5, and 6, the first and second ledges 52 and 56 are spaced apart from one another in a direction parallel to a thickness Tis of the insert 18. The second ledge 56 may be located nearest to a floor F₃₈₋₂ of the second cavity 38-2, and the first ledge 52 is spaced apart from the second ledge 56 in a direction toward the front face 18A of the insert 18. Thus, when received in the second cavity 38-2, the razor cartridge 106 alone (i.e., without the overcap 112) is held at a position that is lower and closer to the floor F₃₈₋₂, as compared to a position at which the razor cartridge 106′ with the overcap 112 is held.

In addition, the first and second ledges 52 and 56 are both spaced apart from the floor F₃₈₋₂ of the second cavity 38-2. The first ledge 52 is spaced from the floor F₃₈₋₂ such that when the razor cartridge 106′ with the overcap 112 is supported by the first ledge 52, the overcap 112 does not contact the floor F₃₈₋₂ of the second cavity 38-2. The second ledge 56 is also spaced from the floor F₃₈₋₂ such that when the razor cartridge 106 alone (without the overcap 112) is supported by the second ledge 56, the razor cartridge 106 does not contact the floor F₃₈₋₂ of the second cavity 38-2. In particular, the razor cartridge 106 is spaced apart from the floor F₃₈₋₂ of the second cavity 38-2, such that blades 114 of the razor cartridge 106 do not contact the floor F₃₈₋₂. Although not shown, it is understood that the second cavities 238-2 depicted in FIG. 8 for receiving additional razor cartridges 106 may comprise a structure that is substantially similar to the structure of the second cavity 38-2 as described herein.

In some examples, one or more of the components of the shaving razor system 20 may be held in their respective first and second cavities 38-1, 38-1′, 238-1, 338-1, 38-2, 238-2, and 338-2 at least in part, by their own weight, and when the case 12 is in the closed position, a depth D₁₂ of the case 12 (see FIG. 4) may be configured such that the top portion 14 of the case 12 contacts at least a portion of one or more of the components. For example, as shown in FIG. 4, the first cavity 38-1′ may be configured such that when the case 12 is in the closed position, an upper wall 14-1 of the top portion 14 of the case 12 contacts a portion of the razor handle 102 to hold the shaving razor 100 in place in the first cavity 38-1′. The first cavities 38-1, 238-1, and 338-1 depicted in FIGS. 1A, 8, and 9 may similarly be configured such that the top portion 14 of the case 12 contacts at least a portion of the shaving razor 100 to hold the shaving razor 100 in place when the case 12 is in the closed position. The second cavities 38-2, 238-2, and 338-2 may also be configured such that the top portion 14 of the case 12 contacts at least a portion of the additional razor cartridges 106, the tube 108, and/or the brush 110 to hold the component(s) in place when the case 12 is in the closed position. Because the insert 18, 18′, 218, 318 comprises a flexible and/or deformable material, the insert 18, 18′, 218, 318 may be configured/sized to compress or deform when the case 12 contacts the portion(s) of the component(s) of the shaving razor system 20 to hold the component(s) securely in place without damaging the component(s), the case 12, and/or the insert 18, 18′, 218, 318.

In other examples, one or more portions of the cavities 38, 38′, 238, and 338 may be configured to at least partially secure one or more of the components of the shaving razor system 20 using a friction or interference fit. For example, with reference to FIGS. 3, 5 and 6, the additional razor cartridge 106, 106′ either alone or with the overcap 112 may be secured in the second cavity 38-2, at least in part, via an interference fit. As shown in FIGS. 5 and 6, when the razor cartridge 106′ with the overcap 112 is inserted into the second cavity 38-2 and rests on the first ledge 52, portions 51-1 and 51-2 of the first section 50 engage a portion 113A-2 and 113B-2 of the respective outer end 113A and 113B of the overcap 112 to hold the razor cartridge 106′ and the overcap 112 in position in the first section 50 via an interference fit. These portions 51-1 and 51-2 that engage the outer ends 113A and 113B of the overcap 112 may be located at or near junctions of the third side wall 50-3 with the first and second side walls 50-1 and 50-2. Although not visible in FIGS. 5 and 6, portions of the first section 50 at or near junctions of the fourth side wall 50-4 (see FIG. 2) with the first and second side walls 50-1 and 50-2 may similarly engage portions of the outer ends 113A and 113B of the overcap 112 via an interference fit.

As shown in FIGS. 3 and 6, when the razor cartridge 106 without the overcap 112 is inserted into the second cavity 38-2 and the razor cartridge 106 rests on the second ledge 56, portions 55-1 and 55-2 of the second section 54 engage a portion 107A-2 and 107B-2 of the respective outer edge 107A and 107B of the razor cartridge 106 to hold the razor cartridge 106 in position in the second section 54 via an interference fit. These portions 55-1 and 55-2 that engage the outer edges 107A and 107B of the razor cartridge 106 may be located at or near junctions of the third side wall 54-3 with the first and second side walls 54-1 and 54-2. Although not visible in FIGS. 3 and 6, portions of the second section 54 at or near junctions of the fourth side wall (not shown) with the first and second side walls 54-1 and 54-2 may similarly engage portions of the outer edges 107A and 107B of the razor cartridge 106 via an interference fit.

Although not shown, it is understood that one or more of the second cavities 238-2 shown in FIG. 8 for receiving additional razor cartridges 106 may comprise a structure that is substantially similar to the structure of the second cavity 38-2 as described herein. The first cavity 38-1, 38-1′, 238-1, and 338-1 shown in FIGS. 1A, 2-4, 8, and 9 and one or more of the second cavities 338-2 in FIG. 9 may also be configured to receive at least a portion of the shaving razor 100 and/or the accessories 108/110 via an interference fit. Alternatively, or in addition, one or more of the first and/or second cavities 38-1, 38-1′, 238-1, 338-1 and 38-2, 238-2, 338-2 may comprise an undercut (not shown) that receives at least a portion of one or more of the components of the shaving razor system 20 via a snap fit.

The storage assembly as described herein is intended to provide a compact, multi-use container that not only protects the components of the shaving razor system during shipping and serves as packaging in a retail environment, but also serves as a convenient storage and travel kit in a home environment. Inserts in accordance with the present disclosure are flexible and deformable for fast and easy removal from the case but are also robust enough to withstand the demands of repeated placement in, and removal from, the case without damage to the insert. The inserts may comprise a durable material that is easy to clean and can withstand exposure to water, soap, shaving cream, etc. The case and inserts may be cleaned separately to prolong their useful life. The assembly may also be configured to function with specific shaving razor systems or types thereof to ensure that the components of the shaving razor system fit securely in the insert and case. The inserts are robust enough to withstand repeated insertion and removal of the components of the shaving razor system without damage to the insert and without loss of the ability to retain the components of the shaving razor system in the cavities. In addition, because the inserts comprise a flexible and/or deformable material, the insert is able to compress or deform when the closed case contacts one or more portions of the component(s) of the shaving razor system to hold the component(s) securely in place without damaging them, the case, and/or the insert.

The case and inserts may be used to hold, organize, and store the razor handle, additional cartridge(s), and/or accessories for day-to-day use. In configurations in which the insert comprises a support rib, the razor handle with attached razor cartridge may be placed in the first cavity without first installing a protective overcap, as the support rib ensures that the razor cartridge does not contact the floor of the first cavity. Similarly, spare razor cartridges may be inserted into the second cavity with or without the protective overcap, as the two sections and corresponding ledges formed in the second cavity ensure that the razor cartridge is held securely in place and that the razor cartridge is free of contact with the floor of the second cavity. In addition, the inserts may be interchangeable such that multiple different inserts may be used with a single case. For example, as described herein, the inserts may include various cavity configurations for different shaving razor systems, accessories, etc. and may be manufactured to comprise a same general (outer) shape and dimensions so that all of the insert configurations may utilize a single case design. Users may purchase one case and multiple inserts with different configurations that may all be used with the same case. The case and inserts provide a sturdy and secure storage container and/or travel kit that protects the components of the shaving razor system from damage and protects adjacent items from damage caused by contact with one or more of the components of the shaving razor system.

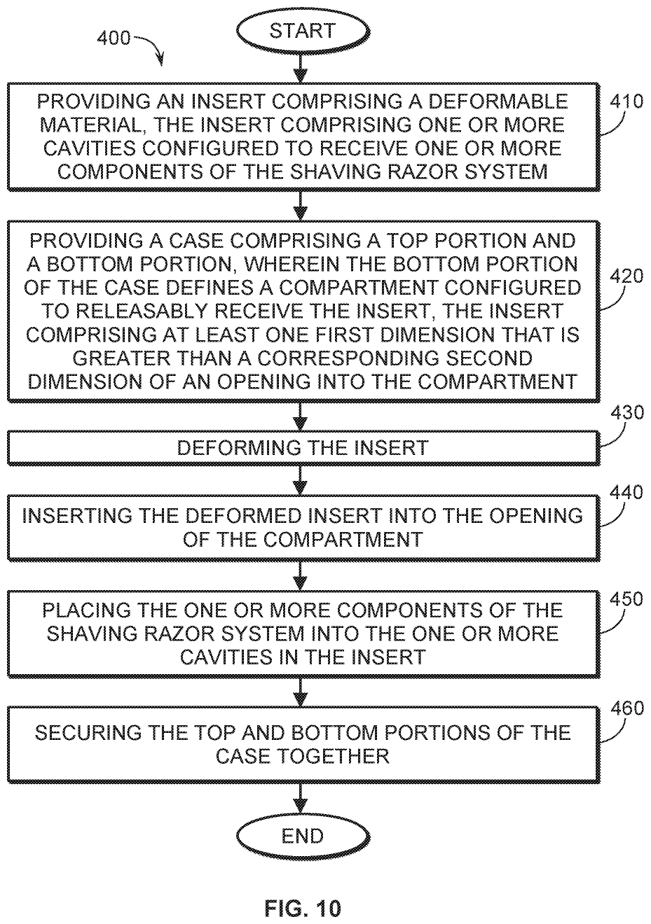

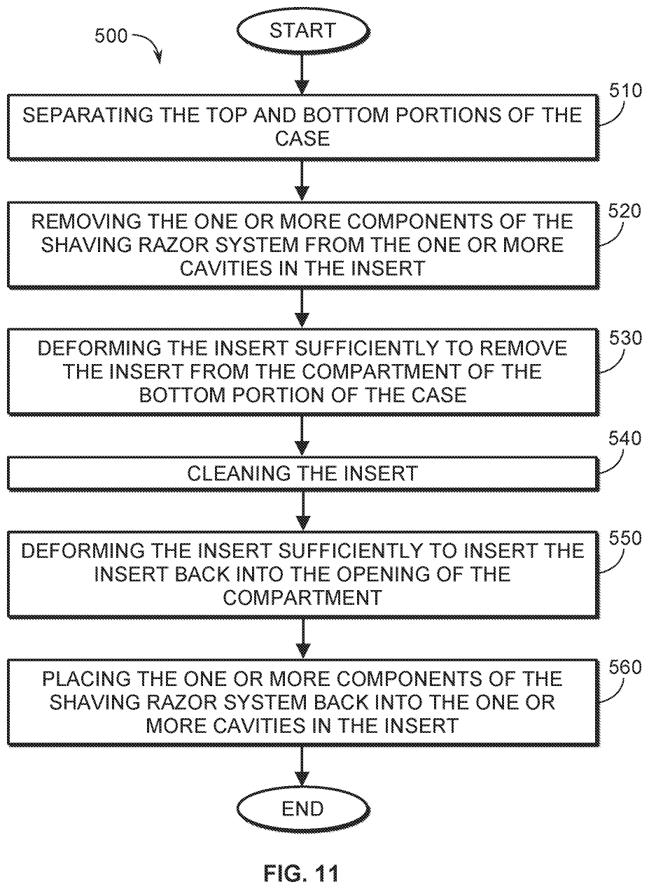

FIGS. 10 and 11 are flow diagrams of methods 400 and 500 of assembling a storage assembly for a shaving razor system, in accordance with the present disclosure. Although reference is made to the storage assembly 10 shown in FIGS. 1A, 2, and 3, it is understood that the disclosed methods may be used with any of the embodiments described herein.

With reference to FIG. 10, the method 400 begins at Step 410 with providing an insert 18 comprising one or more cavities 38-1 and 38-2 that may be configured to receive one or more components of a shaving razor system 20. At Step 420, a case 12 comprising a top portion 14 and a bottom portion 16 is provided. The bottom portion 16 of the case 12 defines a compartment 24 configured to removably receive the insert 18, and the insert 18 comprises at least one first dimension L₁₈ and/or W₁₈ that is greater than a corresponding second dimension L₂₆ and/or W₂₆ of an opening 26 into the compartment 24.

The method 400 continues at Step 430 with deforming the insert 18 and inserting the deformed insert 18 into the opening 26 of the compartment 24 at Step 440. As described herein, the insert 18 is sufficiently flexible and deformable to allow for placement of the insert 18 (without damage) into the compartment 24 via the opening 26, which may be smaller than the insert 18. The insert 18 is deformed by crumpling, folding, bending, etc. and inserting the deformed insert 18 through the opening 26 and into the compartment 24. The insert 18 is also expandable to allow the insert 18 to return to generally an original or initial shape so as to be retained in the compartment 24.

At Step 450, the one or more components of the shaving razor system 20 are placed into the one or more cavities 38-1 and 38-2 in the insert 18. As described herein, the shaving razor system 20 may comprise a shaving razor 100, which may comprise a razor handle 102 alone or with a razor cartridge 104 attached to the razor handle 102; one or more additional razor cartridges 106 that are not attached to the razor handle 102; and/or one or more accessories such as a tube 108 and/or a brush 110. The cavities 38-1 and 38-2 may be configured to receive a respective one of the components of the shaving razor system 20. At Step 460, the top and bottom portions 14 and 16 of the case 12 are secured together, after which the method 400 may conclude. As described herein, the top and bottom portions 14 and 16 of the case 12 may be coupled together so as to be movable relative to one another between an open position and a closed position, and the case 12 may be maintained in the closed position, at least in part, by an interference fit between at least a section of the top and bottom portions 14 and 16.

FIG. 11 illustrates additional optional steps that may be performed following conclusion of the method 400 in FIG. 10. The method 500 begins with separating the top and bottom portions 14 and 16 of the case 12 at Step 510, e.g., moving the case 12 from the closed position to the open position, and removing the one or more components of the shaving razor system 20 from the one or more cavities 38-1 and 38-2 in the insert 18 at Step 520. The method 500 continues at Step 530 with deforming the insert 18 sufficiently to remove the insert 18 from the compartment 24 of the bottom portion 16 of the case 12. As described herein, the insert 18 is sufficiently flexible and deformable to allow for removal of the insert 18 (without damage) following insertion into the case 12, as described in the method 400. For example, the insert 18 may be removed by grasping and deforming the insert 18, as described herein, and removing the deformed insert 18 from the compartment 24 through the opening 26. The insert 18 may optionally comprise one or more pull tabs 32 to assist with removal.

At Step 540, the insert 18 is cleaned. As described herein, the insert 18 is removable from the case 12 so that the insert 18 and case 12 may be cleaned separately, which may help prevent damage to the (metal) case 12 due to contact with water, cleaning chemicals, etc. The method 500 continues with Step 550, in which the insert 18 is deformed sufficiently to insert it back into the opening 26 of the compartment 24. At Step 560, the one or more components of the shaving razor system 20 are placed back into the one or more cavities 38-1 and 38-2 in the insert 18, after which the method 500 may conclude.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A storage assembly for a shaving razor system, the assembly comprising:
a case comprising a top portion and a bottom portion; and
an insert comprising a material having a Shore A hardness of between 40 and 70, wherein the insert comprises one or more cavities configured to receive one or more components of the shaving razor system and wherein the bottom portion of the case defines a compartment configured to removably receive the insert within the bottom portion.

2. The assembly of claim 1, wherein the insert comprises at least one first dimension that is greater than a corresponding second dimension of an opening into the compartment, the insert being sufficiently deformable to allow insertion of the insert through the opening without damage to the insert and also being expandable to allow the insert to return to generally an initial shape so as to be retained in the compartment.

3. The assembly of claim 2, wherein the bottom portion of the case comprises a retainer that extends over at least a portion of the insert.

4. The assembly of claim 3, wherein the bottom portion comprises a peripheral edge extending away from one or more side walls of the bottom portion, at least a portion of the peripheral edge defining the retainer.

5. The assembly of claim 1, wherein a front face of the insert comprises a pull tab to allow for easy removal of the insert from the bottom portion of the case.

6. The assembly of claim 1, wherein the insert is removable from the case, and when positioned in the case, the insert provides a substantially watertight seal against the case.

7. The assembly of claim 1, wherein:
at least one of the top portion or the bottom portion of the case comprises a metal; and
the insert comprises silicone or a thermoplastic elastomer.

8. The assembly of claim 7, wherein the insert is free of any drainage openings extending therethrough.

9. The assembly of claim 1, wherein the one or more cavities comprise:
a first cavity configured to receive a razor handle either alone or in combination with a razor cartridge attached to the razor handle; and
one or more second cavities each configured to receive an additional razor cartridge or an accessory.

10. The assembly of claim 9, wherein the insert further comprises a plurality of aeration slots extending partially through a thickness of the insert and communicating with the first cavity.

11. The assembly of claim 1, wherein the one or more cavities comprise:
a cavity configured to receive a razor handle in combination with a razor cartridge attached to the razor handle, the insert comprising a support rib extending upward from a floor and into the cavity for engaging at least one of the razor handle or the razor cartridge, wherein at least a portion of the razor cartridge facing the floor is spaced apart from the floor.

12. The assembly of claim 1, wherein the one or more cavities comprise:
a first cavity comprising:
a first portion extending along a longitudinal length of the case and being configured to receive a razor handle; and
a second portion configured to receive a razor cartridge attached to the razor handle; and
a second cavity configured to receive a second razor cartridge or an accessory, the second cavity being positioned transverse to a direction of the second portion of the first cavity.

13. The assembly of claim 1, wherein the one or more cavities comprise:
a first cavity configured to receive a razor handle and defining a first longitudinal axis; and
a second cavity configured to receive a razor cartridge or an accessory, the second cavity defining a second longitudinal axis that is parallel to the first longitudinal axis.

14. The assembly of claim 1, wherein a rear face of the insert comprises a plurality of lateral and longitudinal ribs.

15. A storage assembly for a shaving razor system comprising a razor cartridge either alone or in combination with a protective overcap, the assembly comprising:
a case comprising a top portion and a bottom portion; and
an insert received in the bottom portion of the case, the insert comprising a cavity configured to receive the razor cartridge either alone or with the protective overcap, wherein the insert comprises:
a ledge positioned within the cavity and configured to engage and support the protective overcap when the protective overcap is mounted to the razor cartridge.

16. The assembly of claim 15, wherein the ledge supporting the overcap comprises a first ledge, the insert further comprising:
a second ledge positioned within the cavity and configured to directly engage and support the razor cartridge when the protective overcap is removed, wherein the first and second ledges are spaced apart from one another in a direction parallel to a thickness of the insert.

17. The assembly of claim 16, wherein:
when the protective overcap is mounted to the razor cartridge, the first ledge is configured to engage portions of outer ends of the protective overcap; and
when the protective overcap is removed, the second ledge is configured to engage portions of outer edges of the razor cartridge.

18. The assembly of claim 16, wherein:
the first ledge is spaced from a floor of the cavity such that when the razor cartridge is supported by the first ledge, the protective overcap does not contact the floor; and
the second ledge is spaced from the floor of the cavity such that when the razor cartridge is supported by the second ledge, the razor cartridge does not contact the floor.

19. A method of assembling a storage assembly for a shaving razor system, the method comprising:
providing an insert comprising one or more cavities configured to receive one or more components of the shaving razor system;
providing a case comprising a top portion and a bottom portion, wherein the bottom portion of the case defines a compartment configured to removably receive the insert, the insert comprising at least one first dimension that is greater than a corresponding second dimension of an opening into the compartment;
deforming the insert;
inserting the deformed insert into the opening of the compartment;
placing the one or more components of the shaving razor system into the one or more cavities in the insert; and
securing the top and bottom portions of the case together.

20. The method of claim 19, further comprising:
separating the top and bottom portions of the case;
removing the one or more components of the shaving razor system from the one or more cavities in the insert;
deforming the insert sufficiently to remove the insert from the compartment of the bottom portion of the case;
cleaning the insert;
deforming the insert sufficiently to insert the insert back into the opening of the compartment; and
placing the one or more components of the shaving razor system back into the one or more cavities in the insert.
